(19) United States
(12) Patent Application Publication
(10) Pub. No.: US 2014/0150096 A1
(43) Pub. Date: May 29, 2014

(54) METHOD FOR ASSURING INTEGRITY OF MOBILE APPLICATIONS AND APPARATUS USING THE METHOD

(71) Applicant: ELECTRONICS AND TELECOMMUNICATIONS RESEARCH INSTITUTE, Daejeon (KR)

(72) Inventors: Jong Sik MOON, Daejeon (KR); Seung Wan HAN, Gwangju (KR); Hyun Sook CHO, Daejeon (KR)

(73) Assignee: Electronics and Telecommunications Research Institute, Daejeon (KR)

(21) Appl. No.: 13/775,585

(22) Filed: Feb. 25, 2013

(30) Foreign Application Priority Data
Nov. 26, 2012 (KR) 10-2012-0134418

(51) Int. Cl. G06F 21/64

(52) U.S. Cl. CPC G06F 21/64
USPC 726/22

(57) ABSTRACT

An apparatus for assuring integrity of a mobile application or application software (app) includes a developer registration management unit configured to authenticate a mobile app developer based on an authentication means in response to a subscription and registration request of the mobile app developer, and an integrity verification unit configured to verify whether the mobile app has the integrity by unpackaging the mobile app uploaded to an app store server in a packaged state and determine whether to write a code signature of the app store server to the mobile app based on an integrity verification result. Thus, a secure mobile ecosystem can be constructed.

### CLAIM FOR PRIORITY

This application claims priority to Korean Patent Application No. 10-2012-0134418 filed on Nov. 26, 2012 in the Korean Intellectual Property Office (KIPO), the entire contents of which are hereby incorporated by reference.

### BACKGROUND

1. Technical Field

Example embodiments of the present invention relate in general to an apparatus for assuring integrity of a mobile application or application software (app) and more specifically to a mobile app integrity assurance apparatus and method capable of automatically assuring integrity of a mobile app.

2. Related Art

In a mobile ecosystem, a market of smart phones such as Apple's iPhone and Google's Android phones has grown explosively with the revolution of mobile communication. Along with the evolution of the mobile ecosystem, competition and discussion about the development and distribution of mobile apps are actively ongoing. Thus, controversy about security and stability of mobile apps is naturally raised in markets in which applications and services are distributed such as Apple's app store and the Android market. This is because a market operating scheme of an open mobile platform is a structure vulnerable to security and the number of examples of damage such as mobile malicious code contamination is actually increasing. That is, as a mobile device such as a smart phone to which an open operating system is applied becomes rapidly widespread, requirements for the infrastructure to analyze, manage and process integrity, security, and the like of a mobile app in relation to a malicious code or the like are increasing.

Specifically, many mobile malicious codes are occurring in traditional mobile operating systems having high market occupancy such as Symbian, and are rapidly increasing through a mobile ecosystem of mobile open platforms such as Android. As concern about the increasing number of malicious codes, the weakness of security, and the like has become widespread, mobile app stores have become interested in processes of checking integrity and security of mobile apps downloaded by users. In particular, in the case of Apple's app store, significant manpower is devoted to detecting and analyzing malicious action through mobile apps.

However, there is a problem in that significant manpower is required because a general method of detecting malicious action through a mobile app, that is, the general mobile app integrity assurance apparatus and method, is not automatically performed. Thus, there is another problem in that the cost and time for assuring the integrity of the mobile app are increased.

In addition, the general mobile app integrity assurance apparatus and method have a problem in that iterative malicious action of app developers is not prevented because the app developers registering apps in the app store are not tracked.

### SUMMARY

Accordingly, example embodiments of the present invention are provided to substantially obviate one or more problems due to limitations and disadvantages of the related art.

Example embodiments of the present invention provide a mobile app integrity assurance apparatus that can construct a secure mobile ecosystem.

Example embodiments of the present invention provide a mobile app integrity assurance method that provides automated technology capable of securing integrity of a mobile app registered in an app store.

In some example embodiments, an apparatus for assuring integrity of a mobile app includes: a developer registration management unit configured to authenticate a mobile app developer based on an authentication means in response to a subscription and registration request of the mobile app developer; and an integrity verification unit configured to verify whether the mobile app has the integrity by unpackaging the mobile app uploaded to an app store server in a packaged state and determine a repackaging type of the mobile app based on an integrity verification result.

In the apparatus, when the mobile app has an integrity defect, the integrity verification unit may repackage the unpackaged mobile app by including integrity defect information in the mobile app.

In the apparatus, the integrity verification unit may repackage the unpackaged mobile app in one of zeroth to second types when the mobile app has the integrity, the zeroth type may be a type in which the unpackaged mobile app is repackaged to include only a code signature of the mobile app developer in the mobile app of an original state uploaded by the mobile app developer, the first type may be a type in which the unpackaged mobile app is repackaged to include both the code signature of the mobile app developer and a code signature of the app store server, and the second type may be a type in which the unpackaged mobile app is repackaged by performing encryption in the first type.

In the apparatus, the encryption may be performed based on a hash value of a password of a user.

The apparatus may further include: a mobile app registration management unit configured to download the mobile app uploaded by the mobile app developer from the app store server and provide the downloaded mobile app to the integrity verification unit.

The apparatus may further include: a mobile app installation unit configured to provide the mobile app to a user terminal in response to a download request of the user terminal for the mobile app of the app store server.

The apparatus may further include: a system management interface configured to enable a manager to directly perform management when intervention of the manager is necessary in a processing process by the integrity verification unit.

In other example embodiments, a method of assuring integrity of a mobile app in a mobile app integrity assurance apparatus includes: authenticating a mobile app developer based on an authentication means in response to a subscription and registration request of the mobile app developer; verifying whether the mobile app has the integrity by unpackaging the mobile app uploaded to an app store server in a packaged state; and determining a repackaging type of the mobile app based on an integrity verification result.

In the method, the determining of the repackaging type may include: repackaging the unpackaged mobile app by including integrity defect information in the mobile app when the mobile app has an integrity defect.

In the method, the determining of the repackaging type may include: repackaging the unpackaged mobile app in one of zeroth to second types when the mobile app has the integrity, wherein the zeroth type is a type in which the unpackaged mobile app is repackaged to include only a code signature of the mobile app developer in the mobile app of an original state uploaded by the mobile app developer, wherein the first type is a type in which the unpackaged mobile app is repackaged to include both the code signature of the mobile app developer and a code signature of the app store server, and wherein the second type is a type in which the unpackaged mobile app is repackaged by performing encryption in the first type.

In the method, the encryption may be performed based on a hash value of a password of a user.

The method may further include: downloading the mobile app uploaded by the mobile app developer from the app store server so as to verify the integrity of the mobile app.

The method may further include: providing a user with the mobile app in response to a download request of the user for the mobile app of the app store server.

### BRIEF DESCRIPTION OF DRAWINGS

Example embodiments of the present invention will become more apparent by describing in detail example embodiments of the present invention with reference to the accompanying drawings, in which:

FIG. 1 is a diagram schematically illustrating a concept of a mobile app integrity assurance environment for providing an environment for assuring the integrity of a mobile app in accordance with an example embodiment of the present invention;

FIG. 2 is a diagram schematically illustrating functions provided in a developer terminal, an app store security system, and a user terminal so as to implement the mobile app integrity assurance environment;

FIG. 3 is a conceptual diagram schematically illustrating a concept of a mobile app integrity assurance apparatus in accordance with an example embodiment of the present invention;

FIG. 4 is a diagram schematically illustrating mobile app repackaging concepts according to zeroth to second types in accordance with an example embodiment of the present invention;

FIG. 5 is a flowchart illustrating communication between a user terminal and an app store server for showing a concept of the second type in accordance with an example embodiment of the present invention;

FIG. 6 is a flowchart illustrating a process in which a developer is authenticated by the mobile app integrity assurance apparatus; and

FIG. 7 is a flowchart illustrating a process in which the integrity of the mobile app is verified by the mobile app integrity assurance apparatus.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein. Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, preferred embodiments of the present invention will be described in more detail with reference to the accompanying drawings.

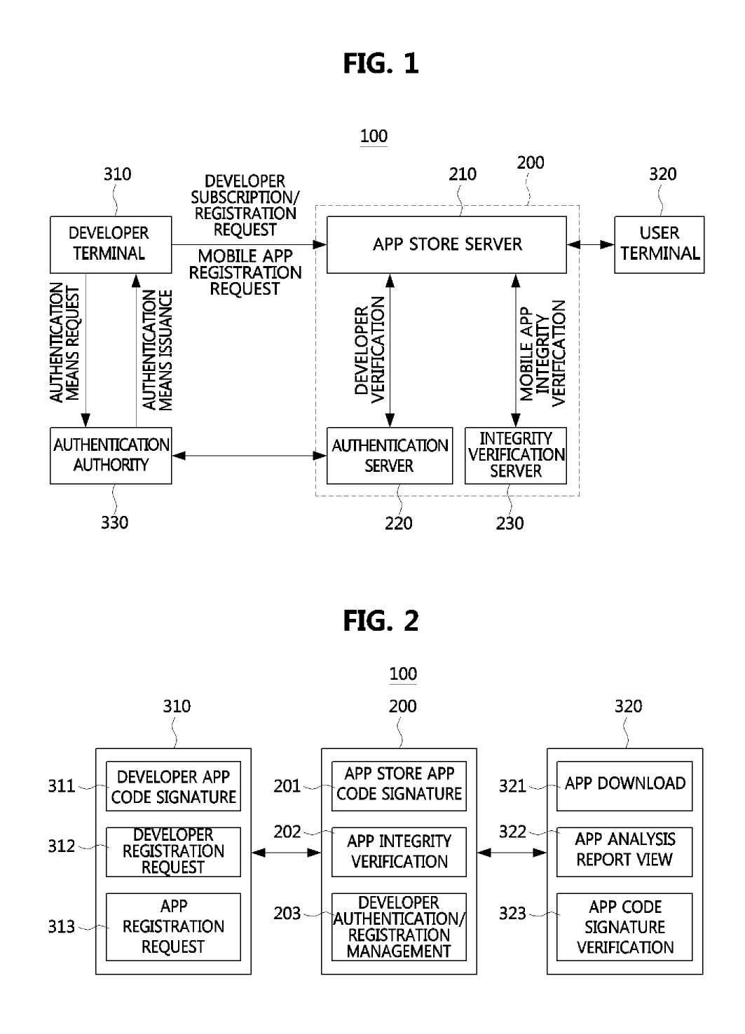

FIG. 1 is a diagram schematically illustrating a concept of a mobile app integrity assurance environment 100 for providing an environment for assuring the integrity of a mobile app in accordance with an example embodiment of the present invention.

The mobile app integrity assurance environment 100 is an environment in which a secure mobile app developed by an authenticated developer can be provided to a user by not only authenticating the app developer, but also verifying the integrity of the mobile app.

For this, the mobile app integrity assurance environment 100 can be implemented by an app store security system 200, a developer terminal 310, a user terminal 320, and an authentication authority 330.

At this time, the app store security system 200 registers the authenticated developer in an app store server 210, verifies the integrity of the mobile app that the developer desires to register in the app store server 210, and registers the verified mobile app in the app store server 210 by adding a code signature of the app store to the verified mobile app, thereby providing the user with the secure mobile app. For this, the app store security system 200 can include the app store server 210, an authentication server 220, and an integrity verification server 230. On the other hand, although the authentication server 220 and the integrity verification server 230 are illustrated separate from the app store server 210 for convenience of description, both the authentication server 220 and the integrity verification server 230, for example, can be configured within the app store server 210. In other words, the authentication server 220 and the integrity verification server 230, for example, can be implemented by one server within the app store server 210 instead of separate servers.

First, the developer receives an authentication means from the authentication authority 330 through the developer terminal 310, and requests the app store server 210 of the app store security system 200 to register the developer based on the authentication means.

Specifically, the developer requests the authentication authority 330 to issue the authentication means, and the authentication authority 330 issues the authentication means to the developer according to the authentication means issuance request of the developer. At this time, a process in which the developer requests the authentication authority 330 to issue the authentication means and receives the authentication means issued by the authentication authority 330 can be performed through the developer terminal 310.

The developer sends a developer subscription and registration request to the app store server 210 of the app store security system 200 using the authentication means issued by and received from the authentication authority 330.

When the developer sends the developer subscription and registration request to the app store server 210, the authentication server 220 verifies the developer based on the authentication means issued by and received from the authentication authority 330.

In addition, the app store server 210 determines whether it is completely appropriate to register the developer in the app store server 210 based on the developer verification result. That is, the app store server 210 determines whether to fully register the developer in the app store server 210.

Specifically, for example, the authentication server 220 verifies the developer based on the authentication means. At this time, when the developer is determined to be an authentic developer whose subscription and registration are possible in the app store server 210, the app store server 210 registers the developer.

On the other hand, the authentication server 220 verifies the developer based on the authentication means of the developer for which verification has been requested. When the developer is determined to be an unauthentic developer whose subscription and registration are not possible in the app store server 210, the app store server 210 ignores the developer subscription and registration request of the developer and does not register the developer.

At this time, the authentication server 220, for example, can communicate with the authentication authority 330 to verify the conformity of the authentication means of the developer for which verification has been requested, and verify whether the authentication means of the developer is an authentic authentication means assigned from the authentication authority 330.

When the developer uploads the mobile app to the app store server 210 along with a mobile app registration request, the integrity verification server 230 verifies the integrity of the mobile app.

In addition, the app store server 210 determines a repackaging type of the mobile app based on the integrity verification result for the mobile app.

Specifically, for example, when the integrity verification server 230 verifies that the mobile app has integrity, the mobile app is repackaged in one of zeroth to second types.

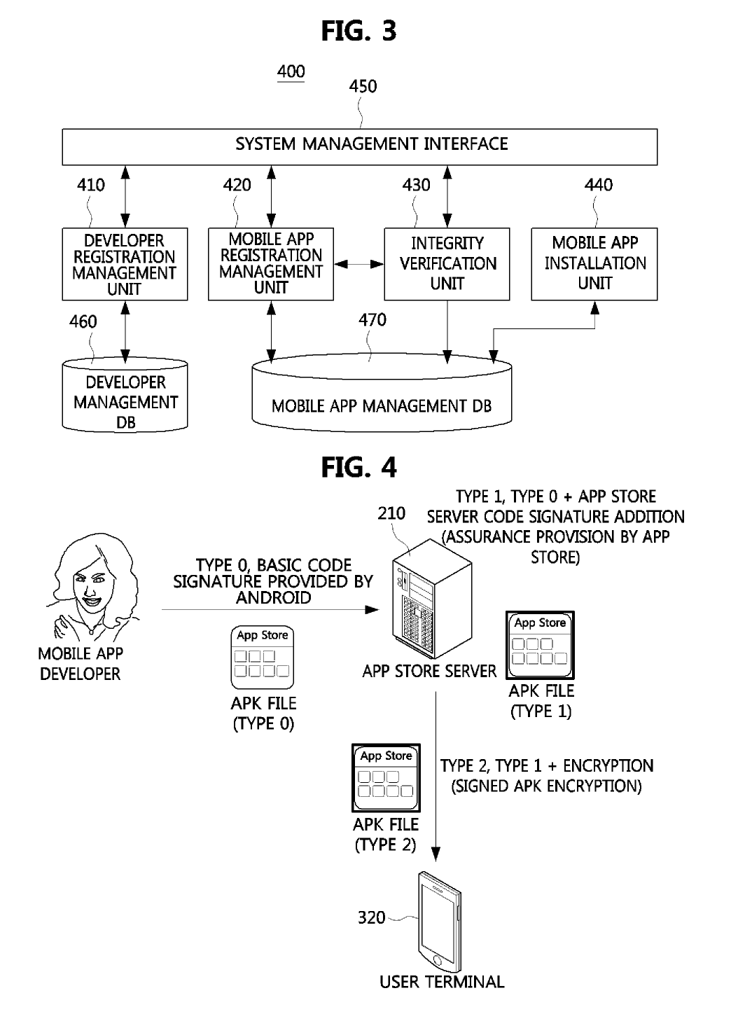

On the other hand, the integrity verification server 230 determines that the mobile app has an integrity defect. The mobile app is repackaged to include integrity defect information indicating the integrity defect. Repackaging of the mobile app will be described in detail later with reference to FIG. 3.

The user can ultimately determine whether to install the mobile app by accessing the app store server 210 using the user terminal 320, downloading the mobile app uploaded by the authenticated developer, and verifying a code signature and integrity defect information of the mobile app.

As described above, the app store server 210 can construct a secure mobile ecosystem to provide users with mobile apps without any malicious code by registering a mobile app of the authenticated developer reflecting the integrity verification result in its own server.

Hereinafter, the mobile app integrity assurance environment 100 in accordance with the example embodiment of the present invention will be described in further detail with reference to FIG. 2.

FIG. 2 is a diagram schematically illustrating functions provided in the developer terminal 310, the app store security system 200, and the user terminal 320 so as to implement the mobile app integrity assurance environment 100.

First, a function provided by the developer terminal 310 to the developer for implementing the mobile app integrity assurance environment 100 will be described.

The developer terminal 310 interworks with the app store security system 200, and hence a verified mobile app developed by the authenticated developer can be ultimately provided to the users.

For this, the developer terminal 310 provides the developer with a developer app code signature function 311, a developer registration request function 312, and an app registration request function 313.

The developer app code signature function 311 enables the developer to include his/her own code signature in a program of a mobile app when the mobile app has been developed. For example, when the developer has developed the mobile app through Java, the developer includes his/her own code signature in the program of the mobile app through Java. In other words, the developer provides information representing the developer of the mobile app by including his/her own code signature in the program of the mobile app through the developer app code signature function 311. Thus, the mobile app developer can be tracked at any time.

The developer registration request function 312 enables the developer to send a developer subscription and registration request to the app store server (210 in FIG. 1). At this time, as described above, the developer receives an authentication means from the authentication authority (330 in FIG. 1) and sends the developer subscription and registration request to the app store server (210 in FIG. 1) using the authentication means.

The app registration request function 313 enables the developer to send a request for registering a mobile app developed by the developer to the app store server (210 in FIG. 1) and upload the mobile app thereto.

In other words, using the developer app code signature function 311, the developer registration request function 312, and the app registration request function 313, the developer includes his/her own app code signature in his/her own developed mobile app program and sends the developer subscription and registration request and the mobile app registration request to the app store server (210 in FIG. 1) along with the authentication means.

Next, functions provided by the mobile app security system 200 so as to implement the mobile app integrity assurance environment 100 will be described.

When there are a request for registering a developer and a request for registering a mobile app, the mobile app security system 200 verifies the developer and the mobile app, registers the verified developer and mobile app in the app store server (210 in FIG. 1), and provides users with the secure mobile app of which integrity has been assured.

For this, the mobile app security system 200 provides an app store app code signature function 201, an app integrity verification function 202, and a developer authentication/registration management function 203.

The app store app code signature function 201 is a function of writing a code signature of the app store server (210 in FIG. 1) to the mobile app of which integrity has been verified. In other words, the app store app code signature function 201 is used to show that the integrity of the mobile app has been assured by the app store server 210 by writing the code signature of the app store server (210 in FIG. 1) to the mobile app of which integrity has been verified. The code signature of the app store will be described in further detail later with reference to FIG. 3.

The app integrity verification function 202 is a function of verifying the integrity of the mobile app registered and uploaded by the developer. Specifically, the app integrity verification function 202 analyzes a package of the mobile app, and verifies the integrity as to whether the mobile app includes a malicious code based on the analysis result.

The developer authentication/registration management function 203 is a function of authenticating and verifying the developer of the mobile app based on the authentication means of the developer and determining whether to register the developer in the app store server (210 in FIG. 1). Specifically, for example, the developer authentication/registration management function 203 enables the developer to be registered in the app store server (210 in FIG. 1) when the developer is determined to be authentic based on the authentication means of the developer, and prevents the developer from being registered in the app store server (210 in FIG. 1) when the developer is determined to be unauthentic. Accordingly, because the developer can be authenticated and tracked, a transparent and secure mobile app distribution environment is assured through mobile app developer authentication.

Finally, a function provided from the user terminal 320 to the user so as to implement the mobile app integrity assurance environment 100 will be described.

The user terminal 320 enables the user to ultimately download the mobile app developed by the authenticated developer from the app store server (210 in FIG. 1) and determine whether to install the mobile app by verifying the code signature included in the mobile app.

For this, the user terminal 320 provides an app download function 321, an app analysis report view function 322, and an app code signature verification function 323.

The app download function 321 is a function of enabling the user to download the mobile app subjected to a mobile app verification process from the app store server (210 in FIG. 1), and install the mobile app based on the app analysis result and the app code signature verification result.

The app analysis report view function 322 enables the user to check the mobile app analysis result. The app code signature verification function 323 enables the user to check the code signature included in the downloaded mobile app, for example, at least one of the app code signature of the developer and the app code signature of the app store, or “integrity defect information.”

At this time, because the app store server 210 does not assure that the mobile app has integrity when there is “integrity defect information,” the user may not install the mobile app downloaded from the app store server 210.

On the other hand, because the app store server 210 assures that the mobile app has integrity when there is no “integrity defect information” and the mobile app is repackaged in one of the zeroth to second types, the user can ultimately install the mobile app in his/her own user terminal, for example, his/her own mobile device.

Thus, the user can install the mobile app by receiving the mobile app registered in the app store server (210 in FIG. 1) and downloaded from the app store server (210 in FIG. 1) and checking the integrity after verifying an app code signature. Through the above-described functions, the user can identify that the integrity of the mobile app is assured and simultaneously the mobile app is a normal app package that has passed through the integrity analysis process of the app store server (210 in FIG. 1).

Hereinafter, the mobile app integrity assurance apparatus in accordance with an example embodiment of the present invention for constructing the app store security system (200 in FIG. 1) will be described in detail with reference to FIG. 3.

FIG. 3 is a conceptual diagram schematically illustrating a concept of the mobile app integrity assurance apparatus 400 in accordance with an example embodiment of the present invention.

As illustrated in FIG. 3, the mobile app integrity assurance apparatus 400 in accordance with the example embodiment of the present invention can include a developer registration management unit 410, a mobile app registration management unit 420, an integrity verification unit 430, a mobile app installation unit 440, and a system management interface 450. The mobile app integrity assurance apparatus 400 in accordance with the example embodiment of the present invention can further include a developer management database (DB) 460 and a mobile app management DB 470.

Here, the developer registration management unit 410 authenticates a developer based on an authentication means of the developer when the developer sends a developer registration request to the app store server (210 in FIG. 1) using the authentication means provided from the authentication authority (330 in FIG. 1).

In addition, the developer registration management unit 410 generates developer authentication information regarding whether to register the developer in the app store server (210 in FIG. 1) based on the developer authentication result or whether to reject the developer subscription and registration request of the developer.

Specifically, for example, when the developer is determined to be an authentic developer capable of being registered in the app store server (210 in FIG. 1), the developer registration management unit 410 generates information indicating that the developer can be registered in the app store server (210 in FIG. 1) and provides the generated information to the app store server (210 in FIG. 1). Thus, the app store server (210 in FIG. 1) registers the developer in the app store server (210 in FIG. 1) based on the developer authentication information indicating that the developer is the authentic developer.

On the other hand, when the developer is determined to be an unauthentic developer incapable of being registered in the app store server (210 in FIG. 1), the developer registration management unit 410 generates information indicating that the developer is not registered in the app store server (210 in FIG. 1), and provides the generated information to the app store server (210 in FIG. 1). Thus, the app store server (210 in FIG. 1) does not register the developer in the app store server (210 in FIG. 1) based on the developer authentication information. At this time, for example, the app store server (210 in FIG. 1) can output a message or the like, which indicates that registration is not possible, to the developer.

At this time, the developer registration management unit 410, for example, can store information regarding the developer requesting the subscription and registration and the authentication result in the developer management DB 460 so as to register and manage the developer.

When the developer sends a mobile app registration request to the app store server (210 in FIG. 1) and uploads a mobile app thereto, the mobile app registration management unit 420 downloads the mobile app from the app store server (210 in FIG. 1) so as to verify the integrity of the mobile app.

At this time, in order to upload the mobile app to the app store server (210 in FIG. 1), for example, the developer includes a code signature in his/her own developed mobile app and packages the mobile app based on a standard format. In other words, the developer packages the mobile app including the code signature based on the standard format, and uploads the mobile app to the app store server (210 in FIG. 1). At this time, the standard format, for example, can be an application package file (APK) format.

In addition, the mobile app registration management unit 420 can manage registration, update, classification, deletion, and the like of mobile apps uploaded by developers in the app store server (210 in FIG. 1).

In addition, in order to provide integrity information regarding a mobile app, the mobile app registration management unit 420 can request the integrity verification unit 430 to analyze the mobile app and manage a result for the analysis request.

On the other hand, the mobile app can be stored and managed in the mobile app management DB 470.

The integrity verification unit 430 receives a mobile app provided from the mobile app registration management unit 420, verifies integrity of the mobile app as to whether the mobile app includes a malicious code, and determines a repackaging state of the mobile app based on the integrity verification result of the mobile app.

Specifically, for example, when the mobile app has an integrity defect, the integrity verification unit 430 repackages the mobile app along with “integrity defect information,” which is information indicating that the mobile app has the integrity defect.

On the other hand, when the mobile app is determined to have integrity, the integrity verification unit 430 repackages the mobile app in one of zeroth to second types without including the integrity defect information.

In the zeroth type, for example, the mobile app including only a code signature of the mobile app developer is repackaged. In the first type, the mobile app including both the code signature of the mobile app developer and a code signature of the app store server (210 in FIG. 1) is repackaged. In the second type, the mobile app including both the code signature of the mobile app developer and the code signature of the app store server (210 in FIG. 1) is encrypted and repackaged.

More specifically, the integrity verification unit 430 receives the packaged mobile app uploaded by the mobile app developer, unpackages the mobile app, and analyzes the package of the mobile app. For example, the integrity verification unit 430 verifies the integrity of the mobile app by analyzing the code signature of the mobile app developer. At this time, when the integrity of the mobile app is verified through the analysis task, the integrity verification unit 430, for example, repackages the mobile app in one of the zeroth to second types based on a certificate of the app store server (210 in FIG. 1).

Hereinafter, the zeroth to second types in accordance with example embodiments of the present invention will be specifically described with reference to FIG. 4.

FIG. 4 is a diagram schematically illustrating mobile app repackaging concepts according to the zeroth to second types in accordance with an example embodiment of the present invention.

First, the zeroth type (type 0) indicates a package including only the developer code signature without applying the code signature of the app store server (210 in FIG. 1). That is, in the zeroth type, the mobile app is output in a state of an original mobile app, that is, in an APK state, when the integrity of the mobile app is verified through the signature verification process on the mobile app. More specifically, for example, in the mobile app repackaging according to the zeroth type, the mobile app is repackaged in an APK file of the original mobile app to which only a basic code signature of the mobile app developer, for example, a basic code signature provided by Android, is applied.

The first type is a type in which the code signature of the app store server is added to the zeroth type. In other words, in the repackaging of the mobile app according to the first type, for example, the mobile app is packaged by further adding the code signature of the app store server to the APK format along with the original developer's code signature. This means that the integrity of the mobile app is assured by the app store server (210 in FIG. 1) through the mobile verification process. That is, the first type assures the integrity of the mobile app through a double signature of the app store server (210 in FIG. 1) in the mobile app.

Specifically, for example, the APK package of the original mobile app can include CERT.RSA, CERT.SF, and MENIFST.MF as metadata information. In the mobile app repackaging according to the type 1, the mobile app is packaged by adding Appstore.SF and Appstore.RSA(.DSA) files to the metadata information in addition to the above-described information.

The type 2 is a type in which the mobile app is packaged in a new format by encrypting the APK file of the type 1 based on a hash value of a password of a user. Specifically, in the repackaging according to the type 2, the APK file of the mobile app including both the code signature of the developer and the code signature of the app store server is encrypted based on the hash value of the password of the mobile app user. Like the type 1, the type 2 assures the integrity of the mobile app by the app store server (210 in FIG. 1).

Somehow, the types 0 to 2, for example, can be selectively selected according to settings of the app store server (210 in FIG. 1).

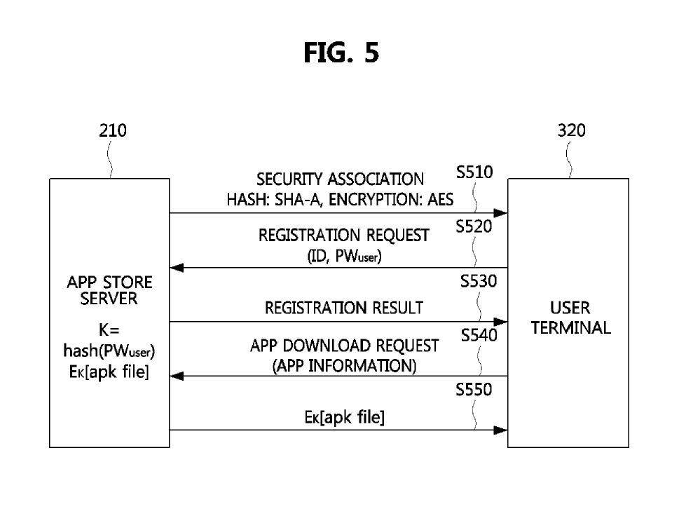

Hereinafter, the type 2 in accordance with the example embodiment of the present invention will be described in further detail with reference to FIG. 5.

FIG. 5 is a flowchart illustrating communication between the user terminal and the app store server for showing a concept of the type 2 in accordance with the example embodiment of the present invention.

First, in a first step S510, the user terminal 320 sends a security association request to the app store server 210. At this time, for example, a secure hash algorithm 1 (SHA-1) can be used as a hash, and an advanced encryption standard (AES) can be used as encryption.

In a second step S520, the user terminal 320 sends a user registration request to the app store server 210. At this time, the user terminal 320 provides a user identifier (ID) and a user's password PWᵤₛₑᵣ to the app store server 210 for the user registration request.

In a third step S530, the app store server 210 sends the user registration result to the user terminal 320.

In a fourth step S540, the user terminal 320 requests the app store server 210 to download a mobile app. At this time, information regarding the app desired to be downloaded is sent together.

In a fifth step S550, the app store server 210 encrypts a file of a mobile app including the code signature of the developer and the code signature of the app store server based on the hash value of the user's password (E_{K}[APK file]), and provides the encrypted file to the user terminal 320.

Here, in K=hash(PWᵤₛₑᵣ) and E_{K}[APK file], the mobile app, which is an APK file, is encrypted based on a key. The key K represents a hash value of the user's password.

On the other hand, although not illustrated, the user downloading the mobile app repackaged in the type 2 extracts the code signature of the developer and the code signature of the app store server through a user-specific decrypting process, and verifies the signatures. For example, the user decrypts the file using the hash value of the user's password.

The remaining configuration of the mobile app integrity assurance apparatus 400 in accordance with the example embodiment of the present invention will be described with reference back to FIG. 3.

When the user requests the app store server (210 in FIG. 1) to download the mobile app, the mobile app installation unit 440 searches for the mobile app from the mobile app management DB 470 and provides the user with the searched mobile app.

At this time, the user verifies the code signatures of the app store server and the developer in the downloaded mobile app. If the verification is completed, the user determines whether to install the downloaded mobile app in the user terminal. When the mobile app is installed, the user can continuously check the update of the mobile app and can delete the mobile app.

Specifically, because the integrity of the mobile app is not assured by the app store server 210 when only the code signature of the developer is included in the downloaded mobile app, the user may not install the mobile app. On the other hand, because the integrity of the mobile app is assured by the app store server 210 when both the code signature of the developer and the code signature of the app store server 210 are included in the mobile app, the user can ultimately install the mobile app.

Finally, the system management interface 450 will be described.

The system management interface 450 enables a manager to directly perform management when the intervention of the manager is necessary in the steps of analyzing and determining integrity verification to be performed by the mobile app integrity assurance apparatus 400 and determining whether to perform registration.

In addition, the system management interface 450 provides necessary settings for each configuration described above, receives execution information including various information regarding an execution result and execution error of each configuration, and reports the execution information to the manager or directly manages the execution information.

Major functions of the system management interface 450, for example, are a system and service management function, a developer interface function, a user interface function, an analysis result check function, a malicious code collection and countermeasure function, and a mobile app analysis virtualization function.

Although the mobile app integrity assurance apparatus 400 is illustrated separately from the app store server 210 of FIG. 1 for convenience of description in FIG. 3, the mobile app integrity assurance apparatus 400, for example, may be configured within the app store server (210 in FIG. 1) and may perform the above-described operations.

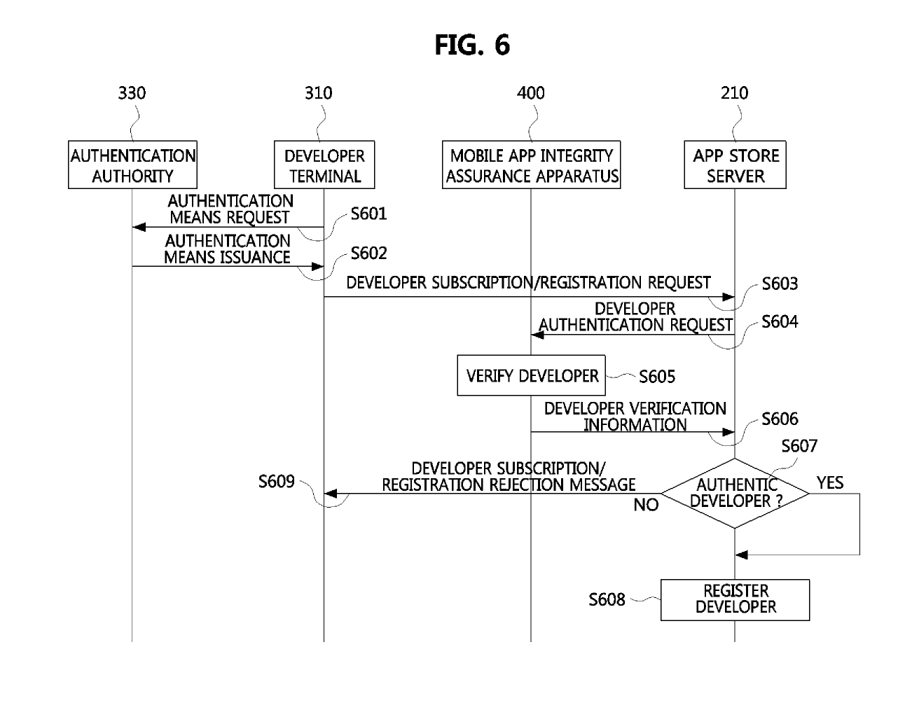

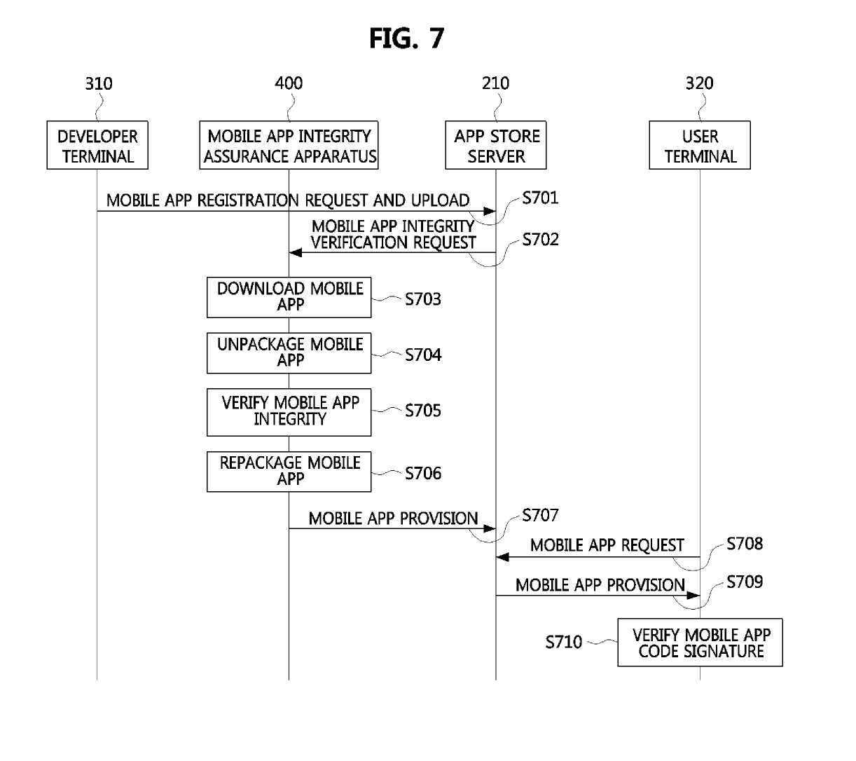

Hereinafter, a mobile app integrity assurance method in accordance with an example embodiment of the present invention will be described with reference to FIGS. 6 and 7.

FIGS. 6 and 7 are flowcharts illustrating the mobile app integrity assurance method implemented by the mobile app integrity assurance apparatus in accordance with the example embodiment of the present invention. FIG. 6 is a flowchart illustrating a process in which a developer is authenticated by the mobile app integrity assurance apparatus, and FIG. 7 is a flowchart illustrating a process in which the integrity of the mobile app is verified by the mobile app integrity assurance apparatus.

First, FIG. 6 will be described. The developer requests the authentication authority 330 to provide an authentication means through the developer terminal 310 (S601) and receives the authentication means issued by the authentication authority 330 (S602).

The developer terminal 310 sends a developer subscription and registration request to the app store server 210 using the authentication means (S603), and hence the app store server 210 requests the mobile app integrity assurance apparatus 400 to authenticate the developer (S604).

Thereafter, the mobile app integrity assurance apparatus 400 verifies the developer based on the authentication means (S605), and provides the app store server 210 with information regarding the developer verification result (S606).

The app store server 210 determines whether the developer is an authentic developer or an unauthentic developer based on the developer verification information (S607), and registers the developer in the app store server 210 when the developer is the authentic developer (S608). On the other hand, when the developer is determined to be unauthentic, the app store server 210, for example, can output a developer subscription and registration rejection message to the developer terminal 310 (S609).

Hereinafter, the mobile app integrity assurance method in accordance with the example embodiment of the present invention will be described with reference to FIG. 7.

First, the authenticated developer requests the app store server 210 to register the developer and uploads a mobile app through the developer terminal 310 (S701). At this time, the developer includes his/her own code signature in the mobile app, packages the mobile app to be suitable for a standard format, and uploads the packaged mobile app.

Subsequently, the app store server 210 requests the mobile app integrity assurance apparatus 400 to verify the integrity of the mobile app (S702).

Subsequently, the mobile app integrity assurance apparatus 400 downloads the mobile app from the app store server 210 (S703), unpackages the mobile app (S704), and verifies the integrity of the mobile app (S705).

Subsequently, the mobile app integrity assurance apparatus 400 repackages the mobile app (S706). In this case, the mobile app integrity assurance apparatus 400 determines a repackaging type of the mobile app based on the integrity verification result of the mobile app. This is the same as described above.

Subsequently, the mobile app integrity assurance apparatus 400 provides the repackaged mobile app to the app store server 210 (S707). On the other hand, when the user terminal 320 requests the app store server 210 to download the mobile app (S708), the app store server 210 provides the mobile app to the user terminal 320 (S709).

The user terminal 320 verifies the code signature of the mobile app (S710), and ultimately determines whether to install the downloaded mobile app.

Specifically, for example, the user, determining whether to install the mobile app by verifying a message and the code signature of the download mobile app, may not install the mobile app including integrity defect information, and may install the mobile app repackaged in one of the types 0 to 2.

In accordance with the example embodiment of the present invention as described above, only the authenticated mobile app developer can register the mobile app in the app store server, the mobile app is automatically analyzed, and information regarding an integrity defect of the mobile app is provided to the user. That is, when the mobile app is uploaded to the app store server, the absence/presence of the integrity defect of the mobile app is automatically verified with respect to the mobile app without any intervention of the manager.

In addition, the convenience for the user can be provided by providing the user with various information based on the integrity verification result.

In addition, the mobile app integrity assurance apparatus in accordance with the example embodiment of the present invention can improve the reliability of a system with high accuracy and minimize management cost and can provide the user with a fast service based on high performance in terms of a processing speed. Thus, the mobile app integrity assurance apparatus in accordance with the example embodiment of the present invention not only verifies the integrity of the mobile app, but also assures the integrity of the mobile app distributed through the app store server, thereby forming a distribution market of a secure mobile app.

Although configurations are separately divided and illustrated in FIGS. 1 to 3 for the convenience of description, the configurations are configured in one block to process the above-described series of steps. At this time, the configurations can be configured by a control unit, a processor, and the like to process the above-described steps.

The mobile app integrity assurance apparatus in accordance with the example embodiment of the present invention as described above can provide an effect of constructing a secure mobile ecosystem capable of checking and verifying the integrity of the mobile app, detecting and removing malicious elements such as malicious programs in advance, and tracking a developer when a phenomenon similar to that of the malicious elements occurs.

In addition, the mobile app integrity assurance method in accordance with the example embodiment of the present invention as described above provides an effect of reducing the consumption of cost and time necessary for an app store manager to manage a malicious program by authenticating a mobile app developer and providing automated technology capable of securing the integrity of the mobile app to assure a secure mobile ecosystem.

While the example embodiments of the present invention and their advantages have been described in detail, it should be understood that various changes, substitutions and alterations may be made herein without departing from the scope of the invention.

What is claimed is:

1. An apparatus for assuring integrity of a mobile application (app), comprising:
a developer registration management unit configured to authenticate a mobile app developer based on an authentication means in response to a subscription and registration request of the mobile app developer; and
an integrity verification unit configured to verify whether the mobile app has the integrity by unpackaging the mobile app uploaded to an app store server in a packaged state and determine a repackaging type of the mobile app based on an integrity verification result.

2. The apparatus of claim 1, wherein, when the mobile app has an integrity defect, the integrity verification unit repackages the unpackaged mobile app by including integrity defect information in the mobile app.

3. The apparatus of claim 1,
wherein the integrity verification unit repackages the unpackaged mobile app in one of zeroth to second types when the mobile app has the integrity,
wherein the zeroth type is a type in which the unpackaged mobile app is repackaged to include only a code signature of the mobile app developer in the mobile app of an original state uploaded by the mobile app developer,
wherein the first type is a type in which the unpackaged mobile app is repackaged to include both the code signature of the mobile app developer and a code signature of the app store server, and
wherein the second type is a type in which the unpackaged mobile app is repackaged by performing encryption in the first type.

4. The apparatus of claim 3, wherein the encryption is performed based on a hash value of a password of a user.

5. The apparatus of claim 1, further comprising:
a mobile app registration management unit configured to download the mobile app uploaded by the mobile app developer from the app store server and provide the downloaded mobile app to the integrity verification unit.

6. The apparatus of claim 1, further comprising:
a mobile app installation unit configured to provide the mobile app to a user terminal in response to a download request of the user terminal for the mobile app of the app store server.

7. The apparatus of claim 1, further comprising:
a system management interface configured to enable a manager to directly perform management when intervention of the manager is necessary in a processing process by the integrity verification unit.

8. A method of assuring integrity of a mobile application (app), comprising:
authenticating a mobile app developer based on an authentication means in response to a subscription and registration request of the mobile app developer;
verifying whether the mobile app has the integrity by unpackaging the mobile app uploaded[ to an app store server in a packaged state; and
determining a repackaging type of the mobile app based on an integrity verification result.

9. The method of claim 8, wherein the determining of the repackaging type includes:
repackaging the unpackaged mobile app by including integrity defect information in the mobile app when the mobile app has an integrity defect.

10. The method of claim 8, wherein the determining of the repackaging type includes:
repackaging the unpackaged mobile app in one of zeroth to second types when the mobile app has the integrity,
wherein the zeroth type is a type in which the unpackaged mobile app is repackaged to include only a code signature of the mobile app developer in the mobile app of an original state uploaded by the mobile app developer,
wherein the first type is a type in which the unpackaged mobile app is repackaged to include both the code signature of the mobile app developer and a code signature of the app store server, and
wherein the second type is a type in which the unpackaged mobile app is repackaged by performing encryption in the first type.

11. The method of claim 10, wherein the encryption is performed based on a hash value of a password of a user.

12. The method of claim 8, further comprising:
downloading the mobile app uploaded by the mobile app developer from the app store server so as to verify the integrity of the mobile app.

13. The method of claim 8, further comprising:
providing a user with the mobile app in response to a download request of the user for the mobile app of the app store server.
